(19) United States
(12) Patent Application Publication
(10) Pub. No.: US 2016/0068445 A1
(43) Pub. Date: Mar. 10, 2016

(54) METHOD FOR PRODUCING POLYCRYSTALLINE CERAMIC STRUCTURE

(71) Applicant: JEN LONG VACUUM INDUSTRIAL CO., LTD., Hsinchu County (TW)

(72) Inventor: Rong-Fu WU, HSINCHU CITY (TW)

(21) Appl. No.: 14/477,260

(22) Filed: Sep. 4, 2014

(51) Int. Cl. C04B 35/64

(52) U.S. Cl. CPC C04B 35/64

(57) ABSTRACT

A method for producing polycrystalline ceramic structure includes the steps of: a) performing a material-feeding procedure, wherein ceramic powder and associated materials are provided, ground and mixed thoroughly; b) performing a molding procedure wherein the mixed materials are pressed and molded through a cold-isostatic-pressing process and form a preform; c) performing a high sintering process and an annealing process to the preform; and d) performing a grinding-and polishing procedure to the preform so as to obtain the polycrystalline ceramic structure that is useful to make laminates for display devices of one or more specifications. The polycrystalline ceramic structure made using the method possesses desired transparence and heat transfer coefficient, and is suitable for making laminates used in display devices.

### BACKGROUND OF THE INVENTION

1. Technical Field

The present invention relates to screen laminates for display devices, and more particularly to a method for producing polycrystalline ceramic structure, which is suitable for making laminates of screens for display devices.

2. Description of Related Art

With the popularization of smartphones, tablet computers, and many other portable electronics, the demands for screen laminates of such devices have been increasing in terms of quality and quantity. In early days, most laminates for display devices had been made of tempered glass until it was found that monocrystalline sapphire is a more suitable material for having better strength, wear resistance, heat transfer coefficient and permittivity. Some designers thus have proposed the use of monocrystalline sapphire for making laminates for display devices and because the mass manufacturing of monocrystalline sapphire laminates is successful, the traditional glass are gradually being replaced. The term “monocrystalline sapphire” mentioned herein refers to monocrystalline sapphire mainly composed of aluminium oxide.

Currently, the manufacturing methods for making monocrystalline sapphire include Kyropoulos Method (also referred to as KY Method), Czochralski Method (also referred to as CZ Method), Edge-defined Film-fed Growth (also referred to as EFG Method) and Advanced Sapphire Furnace (also referred to as ASF Method), wherein ASF Method is particularly prevailing in the industry of display devices. While these existing manufacturing methods do provide high-quality products with desired productive efficiency, all of them share the defects of high facility investments, long investment payback time, high power consumption and low material-recycling rates, making the overall manufacturing costs of laminates high. Hence, there is a need for a more cost-effective approach to providing screen laminates of display devices.

### SUMMARY OF THE INVENTION

In view of the shortcomings of the prior art, it is the objective of the present invention to provide a method for producing polycrystalline ceramic structure that is transparent and suitable for making laminates for display devices. The structure made using the disclosed method further endows anti-scratch property to the laminates made therefrom, so as to enhance the yield and sensitivity of display devices using the laminates. Also, the resulting laminates are fingerprint-proof and smear-proof. It is another objective of the present invention to provide a method for producing polycrystalline ceramic structure that is time-saving and low coast.

For achieving the forgoing objective, the disclosed method for producing polycrystalline ceramic structure comprises the steps of: a) performing a material-feeding procedure, wherein ceramic powder, a transparency-enhancing sintering aid, a dispersant, a binder and a plasticizer are provided, ground and then thoroughly mixed into a mixture; b) performing a molding procedure, wherein the mixture made in the material-feeding procedure is compressed and molded through a compression molding process, so as to form a preform that has predetermined dimensions, and the preform is pressurized in a cold-isostatic-pressing process to have a high and even density, and then the preform is processed by a thermal debinding process so as to perform isotropic shrinkage; c) performing a temperature-controlling procedure, wherein the preform made in the molding procedure is sintered in a high sintering process, and then the sintered preform is annealed in an annealing process so as to reduce stress effects generated in the preform; and d) performing a grinding-and-polishing procedure, wherein the preform made in the temperature-controlling procedure is ground and polished, so as to form the polycrystalline ceramic structure.

With the steps described above, the polycrystalline ceramic structure made using the method of the present invention, as compared with the conventional monocrystalline sapphire (herein basically referred to monocrystalline sapphire composed of aluminium oxide), provides better transparence and heat transfer, and has equally good hardness, wear resistance, electrical insulation and weather-proof property. The disclosed method is designed to replace the conventional methods for making laminates used in display devices, thereby achieving improvements in material cost, energy consumption and production cycle while further enhancing the quality, yield and throughput of the manufactured laminates.

Preferably, in the disclosed method for producing polycrystalline ceramic structure, the material-feeding procedure further comprises a spray granulation process, in which the mixture is granulated.

Preferably, in the disclosed method for producing polycrystalline ceramic structure, the cold-isostatic-pressing process of the molding procedure is a wet cold-isostatic-pressing process.

Preferably, in the disclosed method for producing polycrystalline ceramic structure, the cold-isostatic-pressing process of the molding procedure is a dry cold-isostatic-pressing process.

Preferably, the disclosed method for producing polycrystalline ceramic structure may further comprise a cutting procedure that is performed between the molding procedure and the temperature-controlling procedure, or between the temperature-controlling procedure and the grinding-and-polishing procedure, so as to size the resulting structure as needed.

The following preferred embodiments when read with the accompanying drawings are made to clearly exhibit the above-mentioned and other technical contents, features and effects of the present invention. Through the exposition by means of the specific embodiments, people would further understand the technical means and effects the present invention adopts to achieve the above-indicated objectives. However, the accompanying drawings are intended for reference and illustration, but not to limit the present invention.

### BRIEF DESCRIPTION OF THE DRAWINGS

FIG. 1 is a flowchart of a method for producing polycrystalline ceramic structure according to one preferred embodiment of the present invention.

FIG. 2 is a flowchart of a method for producing polycrystalline ceramic structure according to another preferred embodiment of the present invention.

### DETAILED DESCRIPTION OF THE INVENTION

For further illustrating the means and functions by which the present invention achieves the certain objectives, the following description, in conjunction with the accompanying drawings and preferred embodiments, is set forth as below to illustrate the implement, structure, features and effects of the subject matter of the present invention. Unless otherwise noted, like elements will be identified by identical numbers throughout all figures.

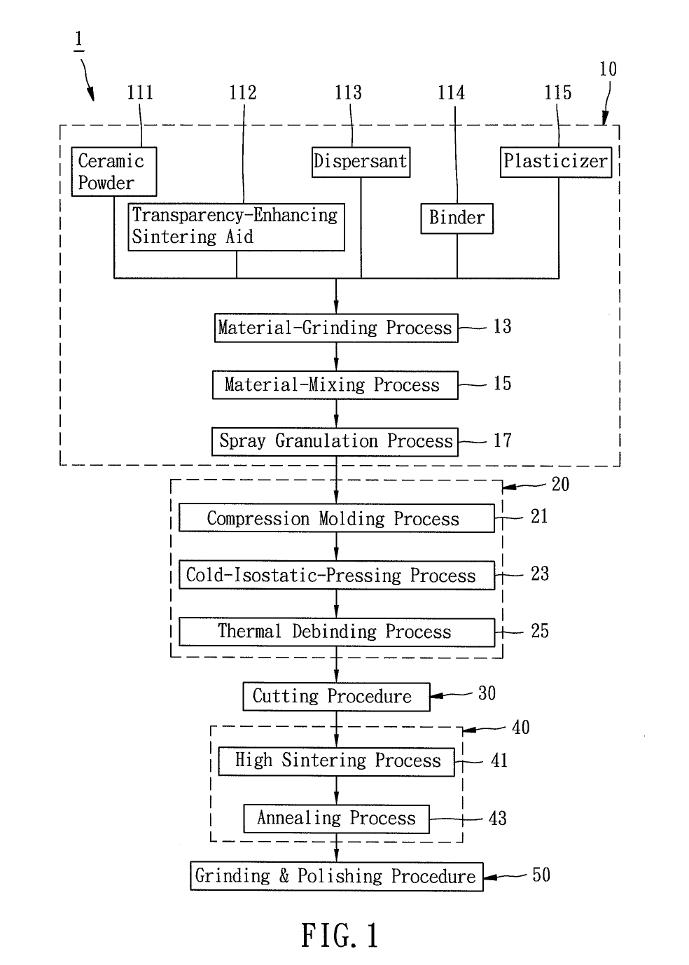

Referring to FIG. 1, in one preferred embodiment of the present invention, a first embodiment for producing laminate polycrystalline ceramic structure that is transparent and can be used to produce display devices, a material-feeding procedure 10, a molding procedure 20, a cutting procedure 30, a temperature-controlling procedure 40, and a grinding-and-polishing procedure 50 are performed successively.

In the material-feeding procedure 10, ceramic powder 111, a transparency-enhancing sintering aid 112, a dispersant 113, a binder 114 and a plasticizer 115 are provided and ground through a material-grinding process 13. Then the ground materials are mixed through a material-mixing process 15 to be thoroughly mixed into a mixture. The mixture processed in the material-mixing process 15 is then put into a spray granulation process 17 in which the mixture is granulated.

In the molding procedure 20, the mixture as a product of the material-feeding procedure 10 is compressed and molded through a compression molding process 21, so as to form a preform having predetermined dimensions. The preform after the compression molding process 21 is then processed through a cold-isostatic-pressing process 23, wherein the preform is compressed to have a higher and even density. Therein, the cold-isostatic-pressing process 23 of the present embodiment may be a wet or dry cold-isostatic-pressing process. Afterward, the preform after the cold-isostatic-pressing process 23 is further processed through a thermal debinding process 25, so as to perform isotropic shrinkage.

In the cutting procedure 30, the preform as a product of the molding procedure 20 is cut in accordance with the specific size of one or more display devices.

In the temperature-controlling procedure 40, the preform that has been cut in the cutting procedure 30 is then processed through a high sintering process 41, so as to endow the preform a structure that is similar to polycrystalline ceramics. Therein, the high sintering process 41 may be any of but is not limited to atmosphere sintering process, vacuum atmosphere sintering process, and hydrogen sintering process. After that, the preform of the polycrystalline ceramic structure receives an annealing process 43, in which the stress effects generated in the preform through the manufacturing is reduced. In the present embodiment, the preform having the polycrystalline ceramic structure is transparent.

In the grinding-and-polishing procedure 50, the preform having the polycrystalline ceramic structure as a product of the temperature-controlling procedure 40 is ground and polished 50, so as to be finalized as a polycrystalline ceramic structure as a laminate applicable to one or more display devices.

Therein, the polycrystalline ceramics structure made using the first embodiment of the present embodiment is transparent.

After the discussion about the procedures, processes, materials and synthetic reactions used in the present embodiment, the effects thus provided will be explained below.

The first embodiment of the present invention advantageously produces the polycrystalline ceramic structure with reduced stress effects, and is helpful to ensure the quality of the products. After the grinding-and-polishing procedure 50 as the finalizing step, the polycrystalline ceramic structure is formed a laminate for display devices of one or more specifications.

The table below provides the comparison between the conventional monocrystalline sapphire (herein referred monocrystalline sapphire composed of aluminium oxide) and the disclosed polycrystalline ceramic structure:

| | | Conventional | Inventive |
|---|---|---|---|
| | | Monocrystalline | Polycrystalline |
| Item | Unit | Sapphire | Ceramics Structure |
| Thickness | mm | 0.5 | 1.0 |
| Density | g/cm³ | 3.95~4.10 | >3.99 |
| Hardness | Mohs Hardness | 9 | 9 |
| Transparence | % | 80 | 85 |
| Heat Transfer | W/mk | 25 | 30~35 |
| Refractive | n | 1.760~1.768 | 1.755~1.765 |
| Index | | | |

As shown in the table, the structure produced using the disclosed first embodiment, as compared with the conventional monocrystalline sapphire, is more transparent and more capable of transferring heat, while its hardness, wear resistance, electrical insulation and weatherproof property are equally good. The disclosed method is designed to replace the conventional methods for making laminates used in display devices, thereby achieving improvements in material cost, energy consumption and production cycle while further enhancing the quality, yield and throughput of the manufactured laminates. The structure made using the disclosed method further endows anti-scratch property to the laminates made therefrom, so as to enhance the yield and sensitivity of display devices using the laminates. Also, the resulting laminates are fingerprint-proof and smear-proof.

Therein, preferably, the ceramic powder 111 used in the material-feeding procedure 10 of the first embodiment is highly pure aluminium oxide powder or powder of other oxides capable of forming transparent ceramics. Its purity is preferably greater than 99.99%, and its average powder size is between 30 nm and 500 nm.

Therein, preferably, the transparency-enhancing sintering aid 112 used in the material-feeding procedure 10 of the first embodiment is from oxides (including but not limited to: ZrO₂, MgO, CaO, Re₂O₃, etc.) or nitrides (including but not limited to: AlN, BN, etc.) or is a composite or compound made of two or more said oxides and nitrides. Re is a rare earth element, may be a composite or compound made of one or more selected from the group including but not limited to Ce, Eu, Er, Nd, Tb, Sm, Tm, Dy, Y, Gd, Pr, Lu, Ho, Pm, La and Yb. The transparency-enhancing sintering aid 112 is provided in an amount of 0 wt %˜2 wt % of the powder mass of the ceramic powder 111, and more preferably 0.05 wt %˜1.0 wt % of the powder mass of the ceramic powder 111.

Therein, preferably, the dispersant 113 used in the material-feeding procedure 10 of the first embodiment is a composite or compound made of one or more selected from the group consisting of polyacrylic acid, polypropylene, polyacrylamide, polyethlene, polyinylidene, polyethylene glycol, gum arabic, gelatin, fish oil, menhaden oil, oleic acid and castor oil. The dispersant 113 is provided in an amount of 0.1 wt %˜5 wt % of the powder mass of the ceramic powder 111, and more preferably 0.5 wt %˜2.5 wt % of the powder mass of the ceramic powder 111.

Therein, preferably, the binder 114 used in the material-feeding procedure 10 of the first embodiment is a composite or compound made of one or more selected from the group consisting of polyvinyl butyral, polyethylene glycol, polyvinyl alcohol, gum arabic, ammonium alginate, methylcellulose, hydroxymethylcellulose, ethylcellulose, hydroxyethylcellulose, methylacrylamide, methylene-bis(acrylamide) and polyoxyethylene. The binder 114 is provided in an amount of 0.1 wt %˜10 wt % of the powder mass of the ceramic powder 111, and more preferably 2.0 wt %˜5.0 wt % of the powder mass of the ceramic powder 111.

Therein, preferably, the plasticizer 115 used in the material-feeding procedure 10 of the first embodiment is a composite or compound made of one or more selected from the group consisting of fatty acids, polyols, fatty acid esters, alkyl citrates, polyester plasticizers and epoxy plasticizers. The plasticizer 115 is provided in an amount of 0.1 wt %˜10 wt % of the powder mass of the ceramic powder 111, and more preferably 2.0 wt %˜5.0 wt % of the powder mass of the ceramic powder 111.

As the above paragraphs describes the procedures, processes, materials, synthetic reactions involved and functional characteristics of one preferred embodiment of the present invention in detail, the following discussion will be directed to the procedures, processes, materials, synthetic reactions involved and functional characteristics of another preferred embodiment of the present invention.

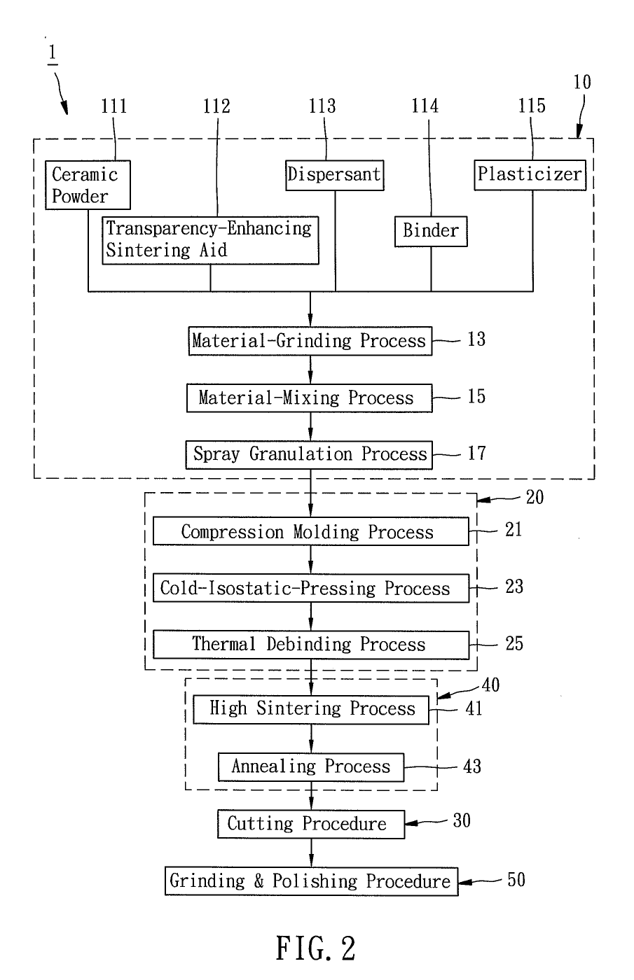

Referring to FIG. 2, a second embodiment for producing polycrystalline ceramic structure according to another embodiment of the present invention has its procedures, processes, materials, synthetic reactions involved, and functional characteristics similar to those of the previous embodiment, except the order of the steps.

Particularly, in the second embodiment, the temperature-controlling procedure 40 of the procedure d) may be advanced so that it is performed before the cutting procedure 30 of the procedure c), and followed by the grinding-and-polishing procedure 50 of the procedure e). This change brings no substantial impacts on the quality and properties of the polycrystalline ceramic structure made using the second embodiment of the preferred embodiment.

For implementing the present invention, modifications may be made to the previously discussed embodiments.

For example, in the first embodiment as described previously, the cutting procedure 30 may be removed from the procedure c), and the temperature-controlling procedure 40 of the procedure d) and the grinding-and-polishing procedure 50 of the procedure e) are directly performed instead. This modification brings no substantial impacts on the quality and properties of the polycrystalline ceramic structure made using the disclosed first embodiment.

As another example, in the second embodiment as described previously, the cutting procedure 30 may be removed from the procedure c), and the grinding-and-polishing procedure 50 of the procedure e) is directly performed instead. This modification brings no substantial impacts on the quality and properties of the polycrystalline ceramic structure made using the disclosed second embodiment.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A method for producing polycrystalline ceramic structure, comprising the steps of:
a) performing a material-feeding procedure (10), wherein ceramic powder (111), a transparency-enhancing sintering aid (112), a dispersant (113), a binder (114) and a plasticizer (115) are provided, ground and then thoroughly mixed into a mixture;
b) performing a molding procedure (20), wherein the mixture made in the material-feeding procedure (10) is compressed and molded through a compression molding process (21), so as to form a preform that has predetermined dimensions, and the preform is pressurized in a cold-isostatic-pressing process (23) to have a high and even density, and then the preform is processed by a thermal debinding process (25) so as to perform isotropic shrinkage;
c) performing a temperature-controlling procedure (40), wherein the preform made in the molding procedure (20) is sintered in a high sintering process (41), and then the sintered preform is annealed in an annealing process (43) so as to reduce stress effects generated in the preform; and
d) performing a grinding-and-polishing procedure (50), wherein the preform made in the temperature-controlling procedure (40) is ground and polished, so as to form the polycrystalline ceramic structure.

2. The method of claim 1, wherein the material-feeding procedure (10) further comprises a spray granulation process (17), in which the mixture is granulated.

3. The method of claim 1, wherein in the material-feeding procedure (10), the transparency-enhancing sintering aid (112) is provided in an amount of 0 wt %˜2 wt % of a powder mass of the ceramic powder (111).

4. The method of claim 1, wherein in the material-feeding procedure (10), the dispersant (113) is provided in an amount of 0.1 wt %˜5 wt % of a powder mass of the ceramic powder (111).

5. The method of claim 1, wherein in the material-feeding procedure (10), the binder (114) is provided in an amount of 0.1 wt %˜10 wt % of a powder mass of the ceramic powder (111).

6. The method of claim 1, wherein in the material-feeding procedure (10), the plasticizer (115) is provided in an amount of 0.1 wt %˜10 wt % of a powder mass of the ceramic powder (111).

7. The method of claim 1, further comprising a cutting procedure (30) that is performed between the molding procedure (20) and the temperature-controlling procedure (40), in which the preform made in the molding procedure (20) is cut.

8. The method of claim 2, further comprising a cutting procedure (30) that is performed between the molding procedure (20) and the temperature-controlling procedure (40), in which the preform made in the molding procedure (20) is cut.

9. The method of claim 3, further comprising a cutting procedure (30) that is performed between the molding procedure (20) and the temperature-controlling procedure (40), in which the preform made in the molding procedure (20) is cut.

10. The method of claim 4, further comprising a cutting procedure (30) that is performed between the molding procedure (20) and the temperature-controlling procedure (40), in which the preform made in the molding procedure (20) is cut.

11. The method of claim 5, further comprising a cutting procedure (30) that is performed between the molding procedure (20) and the temperature-controlling procedure (40), in which the preform made in the molding procedure (20) is cut.

12. The method of claim 6, further comprising a cutting procedure (30) that is performed between the molding procedure (20) and the temperature-controlling procedure (40), in which the preform made in the molding procedure (20) is cut.

13. The method of claim 1, further comprising a cutting procedure (30) that is performed between the temperature-controlling procedure (40) and the grinding-and-polishing procedure (50), in which the preform made in the temperature-controlling procedure (40) is cut.

14. The method of claim 2, further comprising a cutting procedure (30) that is performed between the temperature-controlling procedure (40) and the grinding-and-polishing procedure (50), in which the preform made in the temperature-controlling procedure (40) is cut.

15. The method of claim 3, further comprising a cutting procedure (30) that is performed between the temperature-controlling procedure (40) and the grinding-and-polishing procedure (50), in which the preform made in the temperature-controlling procedure (40) is cut.

16. The method of claim 4, further comprising a cutting procedure (30) that is performed between the temperature-controlling procedure (40) and the grinding-and-polishing procedure (50), in which the preform made in the temperature-controlling procedure (40) is cut.

17. The method of claim 5, further comprising a cutting procedure (30) that is performed between the temperature-controlling procedure (40) and the grinding-and-polishing procedure (50), in which the preform made in the temperature-controlling procedure (40) is cut.

18. The method of claim 6, further comprising a cutting procedure (30) that is performed between the temperature-controlling procedure (40) and the grinding-and-polishing procedure (50), in which the preform made in the temperature-controlling procedure (40) is cut.
